(19) United States
(12) Patent Application Publication
(10) Pub. No.: US 2023/0011386 A1
(43) Pub. Date: Jan. 12, 2023

(54) RODENT SCREEN FOR ELECTRICAL CONNECTIONS SYSTEM AND METHOD

(71) Applicant: Vanguard Cage, LLC, The Woodlands, TX (US)

(72) Inventor: Nilesh N. Kotecha, The Woodlands, TX (US)

(73) Assignee: Vanguard Masks, LLC, The Woodlands, TX (US)

(21) Appl. No.: 17/371,966

(22) Filed: Jul. 9, 2021

(51) Int. Cl. A01M 29/30

(52) U.S. Cl. CPC A01M 29/30

(57) ABSTRACT

A system for limiting access by rodents to an electrical socket, wire or other element includes a mesh sufficiently sized in width to wrap at least a portion of the electrical element and sufficiently sized in length to extend along at least a portion of the electrical element and a connector for engaging the mesh around the electrical element.

### TECHNICAL FIELD

The invention generally relates to shields, and more particularly relates to rodent screens for electrical facilities.

### BACKGROUND

Rodents, such as squirrels, rats, and others, tend to be attracted to electrical light strings, cameras, and other electrical devices and connections. The rodents often chew on the electrical devices and connections. These electrical devices and connections may be shielded with non-conductive materials, such as rubbers, plastics, and the like. Nevertheless, rodents often chew and otherwise destruct the devices and connective electrical links.

It would, therefore, be a significant improvement in the art and technology to provide screens or shields to help prevent rodents from destructing electrical elements, such as light strings, cameras, illuminating light, and the like.

### SUMMARY

An embodiment of the invention is a system including a mesh sufficiently sized in width to wrap at least a portion of an electrical element and sufficiently sized in length to extend along at least a portion of the electrical element and a connector for engaging the mesh around the electrical element.

Another embodiment of the invention is a method of manufacture including forming a screen of desired size and shape and engaging the screen wrapped to an electrical element.

Another embodiment of the invention is a method of protecting an electrical device from rodents. The method includes sizing a screen to wrap around the electrical device and extend along at least a portion of the electrical device, wrapping the screen around the electrical device, and connecting ends of the screen to retain the screen engaged to the electrical device.

Yet another embodiment of the invention is a method of protecting an electrical device from rodents, including folding a serrated shield against an electrical socket and clamping the serrated shield in engagement to the electrical socket.

Another embodiment of the invention is a method of limiting access to an electrical device. The method includes closing respective halves of a clam-shell of a serrated material around the electrical device and retaining the respective halves closed in engagement to the electrical device.

### BRIEF DESCRIPTION OF THE DRAWINGS

The present invention is illustrated by way of example and not limitation in the accompanying figures, in which like references indicate similar elements, and in which:

FIG. 1 illustrates a side and front perspective view of a rodent screen engaged to an electrical socket and wire for a light bulb, according to certain embodiments of the invention;

FIG. 2 illustrates a side and front perspective view of a rodent screen, according to certain embodiments of the invention;

FIG. 3 illustrates a side and front perspective view of another rodent screen, according to certain embodiments of the invention;

FIG. 4 illustrates a front view of a clam-shell rodent screen with a hinge, according to certain embodiments of the invention;

FIG. 5 illustrates a front view of another clam-shell rodent screen with a hinge, according to certain embodiments of the invention;

FIG. 6 illustrates a top view of a rodent screen, according to certain embodiments of the invention;

FIG. 7 illustrates a bottom and side perspective view of a clam-shell rodent screen for folding on a hinge to secure the screen to a light bulb socket, according to certain embodiments of the invention; and

FIG. 8 illustrates a front and top perspective view of a rodent screen engaged to a light bulb socket and wire for retention by a tie, according to certain embodiments of the invention.

### DETAILED DESCRIPTION

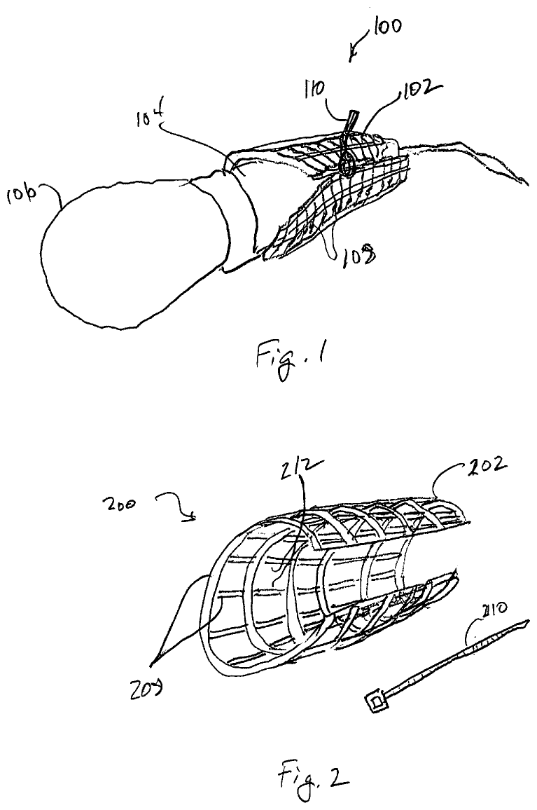

Referring to FIG. 1, a device 100 for shielding an electrical plug or other electrical connectivity element includes a screen 102. The screen 102 is sized and configured to wrap a bulb socket 104 for a light bulb 106, or other electrical connection. For non-exclusive example, the screen 102 is a wire frame 108 or other screen material that is capable of bending or forming to place around the socket 104 or other electrical element.

The wire frame 108 of the screen 102 may connect or secure at ends wrapped around the electrical element, such as for non-exclusive example, a clamp or tie 110 connects the wire frame 108 in place shielding the electrical element.

Referring to FIG. 2, a device 200 for shielding an electrical element includes a screen 202. The screen 202 is, for non-exclusive example, formed of structures 208, such as a mesh, wire, serrated sheet or other frame. The structures 208 may, in non-exclusive embodiments, include spaces 212 between the structures 208, such that the screen 202 can be see through. The spaces 212 between the structures 208 is limited to prevent rodents or other animals from accessing for chewing or tearing at an electrical element (shown as non-exclusive example in FIG. 1) surrounded by the screen 202. In a non-exclusive embodiment, the screen 202 is a wire or other bendable or foldable netting formed of material sufficient to limit rodent access. The screen 202 is wrapped, such as into a cylinder form, around an electrical socket, fixture, wire or other element and secured in place by a tie 210 or other connector at extents of the wrapped screen 202.

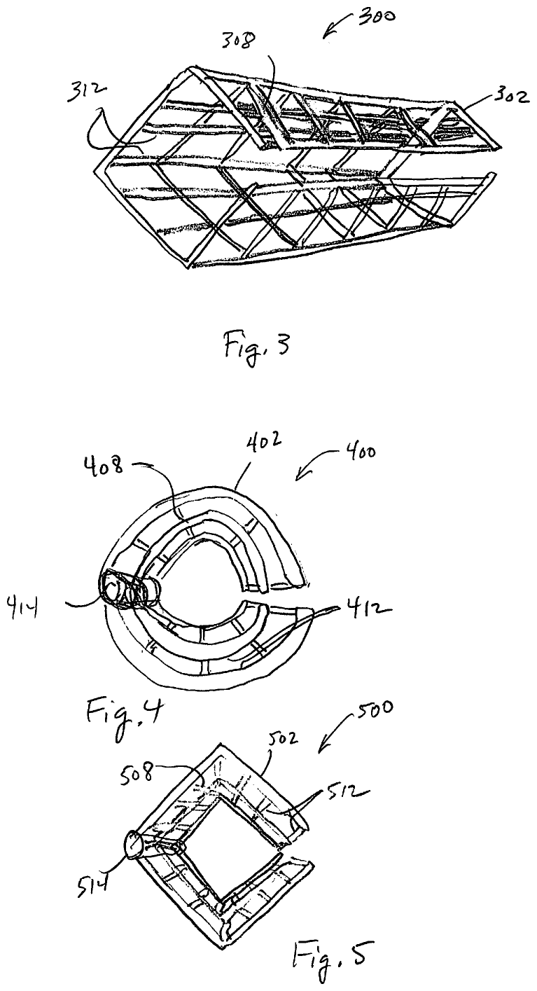

Referring to FIG. 3, an alternative embodiment of a device 300 shields and electrical plug or other electrical element. The device 300 includes a rectangular and extended structure 308 of wire or frame mesh 302. The structure 308 wraps an electrical element or connection (not shown in FIG. 3), such as for non-exclusive example of lights of a light string, an electronic camera, a landscape light, an accent light, or other electrical device. The structure 308 prevents rodents from accessing the electrical device to chew or degrade the electronics. Spaces 312 between the structure 308 are sized accordingly to preclude access by rodents and to allow view to the electrical device.

Referring to FIG. 4, another device 400 restricts access by rodents to an electrical plug, socket, wire or other electrical element. The device 400 includes a clam shell and extended structure 408. Spaces 412 between the structure 408 are sized to allow the electrical element to be viewed and to restrict rodent intrusion. The structure 408 includes a hinge 414 along length of the device 400. The hinge 414 connects respective semicircular halves to form a cylinder of the device 400 when extents along the length opposite the hinge are touching or brought together.

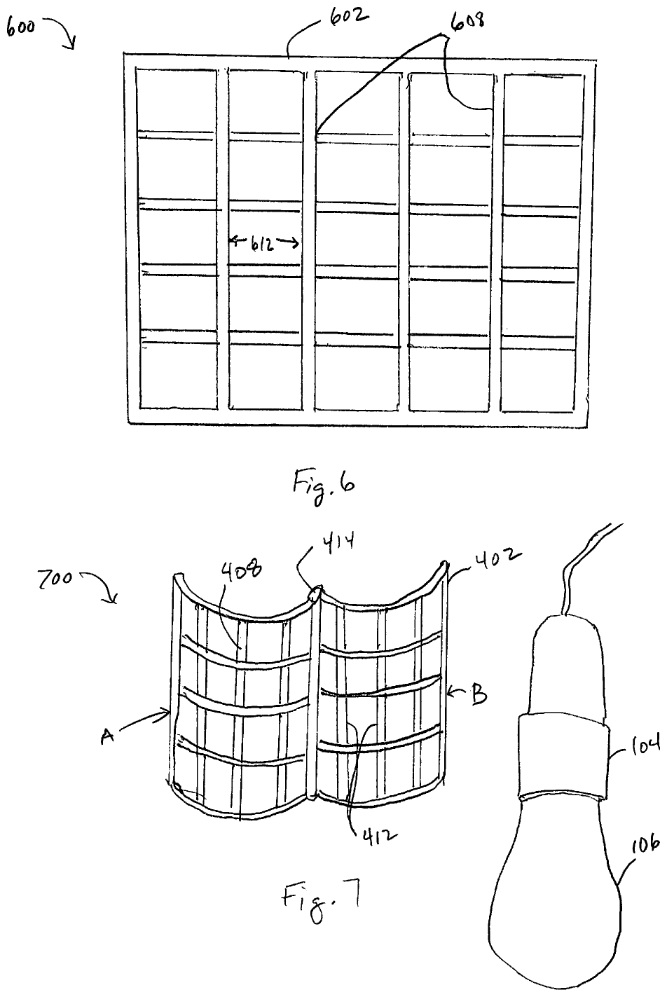

Referring to FIG. 5, an alternative device 500 includes an extended structure 508 of wire or frame mesh 502. In cross section of the extension of the structure 508, the structure 508 forms two halves of a square or rectangle connected along the extended length by a hinge 514. Spaces 512 between the structure 508 of the mesh 502 are sized to allow view to within the mesh 502 and to prevent rodents from accessing an electrical device (not shown in FIG. 5) surrounded by the mesh 502.

In operation of the foregoing, the mesh of the devices is circled or otherwise wrapped around an electrical device or element. The mesh can be, for non-exclusive example, flexible to allow bend or other configuration to fit the electrical device or connection. In other non-exclusive example, the mesh can be rather rigid (or not) and a hinge or other element allows the mesh to be configured around an electrical device or connection. A clasp, tie, clamp, latch or other connector can be attached to the ends or extents of the mesh to retain the mesh device protecting the electrical device or connection.

Referring to FIG. 6, a device 600 includes a wire or other mesh 602. Structures 608 forming the mesh may be of any geometric configuration, with spaces 612 between structures 608 sufficient to allow viewing through the spaces 612 and to limit access through the spaces 612 by rodents. The device 600 is a non-exclusive example of the configurations of devices 100 and 200 of FIGS. 1 and 2.

In operation, the mesh 602 of the device 600 is wrapped around an electrical connector, device or element and secured at ends of the mesh 602 with a tie, clasp, latch or other connector (not shown in FIG. 6). The mesh 602 limits rodent accessibility to the electrical element. The mesh 602 is retained in engagement to the electrical element during use. If and when desired, the device 600 may be removed from engagement to the electrical element, such as for non-exclusive example by dislodging the connector. In use, the device 600 protects the electrical element from damage caused by rodents and the like.

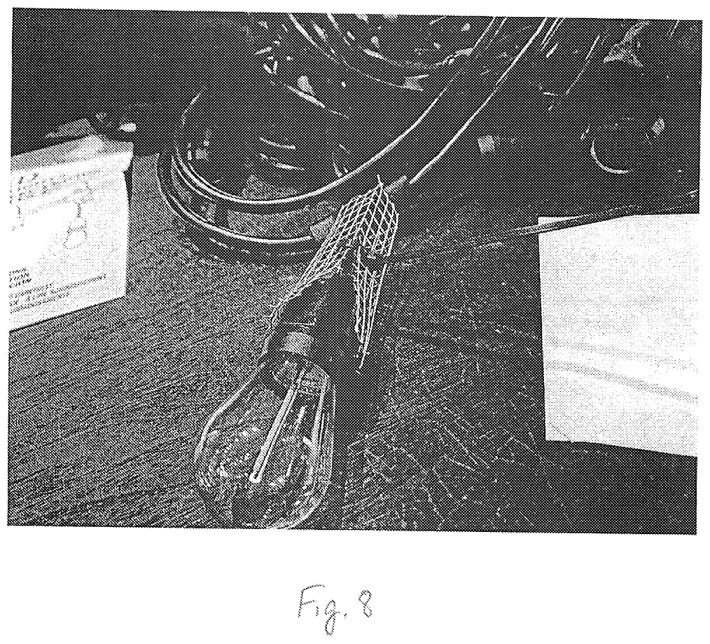

Referring to FIG. 7, a device 700 includes a clam-shell mesh 402 configuration in which two semicircle halves A, B (in cross-section along extension) are joined by a hinge 414 along extension of the mesh 402. The halves A, B are each placed along either side of an electrical element, such as a socket 104 of a bulb 106 of a light or light string. The halves A, B are each placed along either side of an electrical element, such as a socket 104 of a bulb 106 of a light or light string. The halves A, B are folded to engage along edges opposing the hinge 414. A clasp, tie, or other connector retains the device 700 protecting the electrical element.

Referring to FIG. 8, a device 800 is an example of the devices 100, 200 and 700 of FIGS. 1, 2 and 7 in use with a string light socket and bulb. The device 800 includes a flexible wire mesh that is folded around the socket and extends substantially cylindrically around portions of the socket and a wire connected to the socket. A tie engages the two extended edges of the mesh to retain the device 800 in positional engagement with the electrical elements.

The foregoing devices of a mesh or shield are manufacturable of a wide variety of materials. For nonexclusive example, the structures of the devices may be or include any of a wide range of deformable, conformable or relatively rigid materials that will maintain sufficient structural impediments to a rodent when in use protecting an electrical element. Certain materials may include, without limitation, metal, aluminum, tin, composite, hard plastics, and others, including combinations of materials whether any of these or any others. Moreover, the devices may be of varied shape and spaces between structures of the devices may be variously sized sufficient to view a centrally engaged electrical element and to limit access to the electrical element by rodents or other harmful actors. A wide variety of retention devices, such as for non-exclusive examples tie, clasp, latch, lock, hinge lock, or other retainers may be employed for retaining the devices engaged to the electrical element. In manufacture, the structures of the mesh may be welded, molded, stamped, cut, and otherwise configured. All other possibilities, now or hereafter known or available, are included.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention. Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

What is claimed is:

1. A system, comprising:
a mesh sufficiently sized in width to wrap at least a portion of an electrical element and sufficiently sized in length to extend along at least a portion of the electrical element; and
a connector for engaging the mesh around the electrical element.

2. The system of claim 1, wherein the mesh is bendable to conform substantially to surround the electrical element.

3. The system of claim 1, wherein the mesh if formed as a clam shell joined by a hinge to conform substantially to surround the electrical element.

4. The system of claim 2, wherein the mesh is formed of a material selected from the group consisting of: metal, aluminum, tin, plastics, composite, other conformable material, and combinations of these.

5. The system of claim 3, wherein the mesh is formed of a material selected from the group consisting of: metal, aluminum, tin, plastics, composite, other conformable material, and combinations of these.

6. The system of claim 3, wherein the clam shell is formed of a rigid material selected from the group consisting of: metal, aluminum, tin, plastics, composite, other relatively rigid material, and combinations of these.

7. A method of manufacture of the device of claim 1, comprising:
cutting a wire mesh to desired width to generally encircle the electrical element and desired length to generally cover the electrical element.

8. A method of manufacture of the device of claim 1, comprising:
molding a screen to desired width to generally encircle the electrical element and desired length to generally cover the electrical element.

9. A method of manufacture of the device of claim 2, comprising:
forming a bendable screen.

10. A method of manufacture of the device of claim 3, comprising:
forming respective halves of a clam-shell of a bendable material; and
connecting the halves to a hinge.

11. A method of manufacture of the device of claim 3, comprising:
forming respective halves of a clam-shell of a rigid material; and
connecting the halves to a hinge.

12. A method of manufacture of the device of claim 3, comprising:
forming respective halves of a clam-shell of a bendable material; and
connecting the halves to a hinge.

13. A method of manufacture of the device of claim 3, comprising:
forming respective halves of a clam-shell of a rigid material; and
connecting the halves to a hinge.

14. A method of protecting an electrical device from rodents, comprising:
sizing a screen to wrap around the electrical device and extend along at least a portion of the electrical device;
wrapping the screen around the electrical device; and
connecting ends of the screen to retain the screen engaged to the electrical device.

15. A method of protecting an electrical device from rodents, comprising:
folding a serrated shield against an electrical socket; and
clamping the serrated shield in engagement to the electrical socket.

16. A method of limiting access to an electrical device, comprising:
closing respective halves of a clam-shell of a serrated material around the electrical device; and
retaining the respective halves closed in engagement to the electrical device.
